(19) United States
(12) Patent Application Publication
(10) Pub. No.: US 2026/0184577 A1
(43) Pub. Date: Jul. 2, 2026

(54) PROCESS AND APPARATUS FOR PRODUCING ULTRA PURE CO2 IN A CARBON CAPTURE PROCESS

(71) Applicant: UOP LLC, Des Plaines, IL (US)

(72) Inventors: Anh Ngo, Cypress, TX (US); John D. Wilkinson, Midland, TX (US); Bradley Russell, Longmont, CO (US); Oluwaseyi Kayode, Cypress, TX (US); Kyle Cuellar, Fulshear, TX (US)

(21) Appl. No.: 19/346,889

(22) Filed: Oct. 1, 2025

Related U.S. Application Data
(60) Provisional application No. 63/739,161, filed on Dec. 27, 2024.

(51) Int. Cl. C01B 32/50; B01D 53/047; B01D 53/26; F25J 3/02

(52) U.S. Cl. CPC C01B 32/50; B01D 53/047; B01D 53/26; F25J 3/0266; F25J 3/0295; B01D 2257/80; C01P 2006/80; F25J 2200/32; F25J 2200/74; F25J 2215/80; F25J 2245/02

(57) ABSTRACT

Processes for producing two CO₂ streams having different purities, including one stream comprising ultra high purity CO₂. The processes incorporate a second fractionation column in a CO₂ fractionation process. The bottoms stream from the first cryogenic fractionation column is sent to the second CO₂ fractionation column. The second CO₂ fractionation column can produce ultra high purity CO₂. The bottoms stream from the first column can be divided and a portion of the bottoms stream can be recovered as a second CO₂ product stream having a lower purity than the purity of the product stream.

### RELATED APPLICATIONS

This application claims priority to U.S. Provisional Patent Application Ser. No. 63/739,161, filed on Dec. 27, 2024, the entirety of which is incorporated herein by reference.

### BACKGROUND

Traditional mixed refrigerants used in cryogenic capture of carbon dioxide may include carbon dioxide itself, along with a mixture of light hydrocarbons. These mixed refrigerants allow for efficient refrigeration; however they can require additional measures to be taken to reduce the risk of flammability. CO₂ may be used as a non-flammable refrigerant, but results in a less efficient scheme as the stream to be cooled is often near the CO₂ freeze point.

Processes for recovering high purity CO₂ streams have been developed. In some cases, a customer may want to produce primary CO₂ product for sequestration and a second CO₂ product stream of differing purity for some other use. For example, a slipstream of beverage-grade CO₂ provides a saleable product for the consumer market that can be adjusted based on economic conditions. In another example, two primary product streams of differing purity could be desired, e.g., one CO₂ stream to be sent to a pipeline and a second stream for ship transport.

In addition, some customers desire ultra high purity CO₂. One method of producing ultra high purity CO₂ uses catalytic oxidation. Using catalytic oxidation for removal of trace impurities (CO, methane, and H₂) to reach food-grade purity requires vaporization of the liquid CO₂ product, injection of oxygen, catalytic reaction at high temperature (about 400° C.), chilling/re-liquefaction, and oxygen removal. The process is expensive due to the number of process steps. Some customers may need a CO₂ product meeting the quality for semiconductor grade (e.g., 99.999 mol % purity).

Therefore, there is a need to produce two CO₂ product streams of differing purity from the same process. There is also a need for simplified processes for producing high purity CO₂.

### BRIEF DESCRIPTION OF THE DRAWINGS

FIG. 1 is an illustration of one embodiment of a process according the present invention.

FIG. 2 is an illustration of another embodiment of a process according the present invention.

### DESCRIPTION

The present invention meets this need by using a second fractionation column in the cryogenic CO₂ fractionation process.

A cryogenic CO₂ fractionation process has been developed to recover high-purity carbon dioxide from various streams, such as existing SMR hydrogen plant tail gas, gasification or autothermal reforming plant syngas, steel plant blast furnace off gas, cement plant off gas, and the like.

The cryogenic CO₂ fractionation process can be adapted to recover two CO₂ streams having different purities and/or an ultra high purity CO₂ stream.

For example, a slipstream of high-pressure primary CO₂ liquid product at 99.0 mol% purity from the first distillation column is expanded across a valve to lower pressure. This chilled, two-phase stream is passed to the top of a second distillation column. A low-grade heat source (e.g., cooling water) is used to reboil the second column to produce a second ultra-high purity CO₂ product (e.g., greater than 99.9 mol %, or greater than 99.99 mol %, or greater than 99.999 mol %). To avoid CO₂ losses from the second fractionator, the overhead stream (e.g., 97 mol% CO₂) is recycled back to the main inlet gas compressor (inter-stage).

In order to achieve the ultra-pure CO₂ target, a CO₂ polishing system, including the second distillation column (CO₂ Stripper or CO₂ polishing system), treats the CO₂ product from the first distillation column (CO₂ fractionator). The CO₂ polishing system is operated at lower pressure (e.g., 250 psig) compared to the CO₂ fractionator (e.g., 550 psig).

The CO₂ polishing system is designed with a lower pressure cryogenic fractionation column to treat the CO₂ liquid from the first column to achieve higher CO₂ bottoms purity in the second column (e.g., greater than 99.9 mol %, or greater than 99.99 mol %, or greater than 99.999 mol%) with minimum utility consumption due to heat integration. The only utility consumption during normal operation is electric power and cooling water.

The CO₂ polishing system would also enable the process to generate multiple CO₂ product grades, from sequestration grade, to food grade, to beverage grade, to semiconductor grade.

The present process allows the production of high purity CO₂ without the need for the catalytic oxidation required by prior art methods. The present processes with the integrated second fractionation column avoids these costly purification steps.

In some embodiments, the CO₂ product stream purity is greater than 99.9 mol %, or greater than 99.99 mol %, or greater than 99.999 mol %.

In some embodiments, the second CO₂ product stream purity is greater than 95 mol%, or greater than 98 mol %, or greater than 99 mol %.

In some embodiments, the CO₂ product is a liquid with a temperature of about −10° C. to −50° C.

In some embodiments, the second CO₂ product stream is pumped to a pressure greater than 80 bar(g), or greater than 100 bar(g), or greater than 150 bar(g), or greater than 200 bar(g) and passed to a pipeline.

In some embodiments, the operating pressure of the first cryogenic CO₂ fractionation column is 30 bar(g) to 50 bar(g). In some embodiments, the operating pressure of the second cryogenic CO₂ fractionation column is less than 20 bar(g).

In some embodiments, the CO₂ containing stream is compressed in a gas compressor upstream of the first cryogenic CO₂ fractionation column.

In some embodiments, the compressed CO₂ containing stream is dehydrated upstream of the first cryogenic CO₂ fractionation column.

The CO₂ containing stream may be an off-gas stream from a process or a tail gas stream from a PSA system, or both. The amount of CO₂ in the off-gas stream or tail gas stream may vary widely, depending on its source, for example, from 20 mol % to 70 mol %. The PSA system may be used to preconcentrate the stream if the CO₂ concentration is less than 40 mol %, for example.

In some embodiments, the CO₂ containing stream comes from an SMR hydrogen production process, or a gasification process, or a steel production process, or an autothermal reforming process. In some embodiments, the CO₂ containing stream comes from a cement production process or a fluid-catalytic cracking (FCC) process or an SMR hydrogen plant.

In some embodiments, the CO₂ containing stream further comprises hydrogen and carbon monoxide. This type of stream may come from a SMR hydrogen plant tail gas stream, gasification or autothermal reforming plant syngas stream, or a steel plant blast furnace off gas stream, for example.

In some embodiments, the CO₂ containing stream further comprises nitrogen and oxygen. This type of stream may come from a cement plant off gas stream, for example.

Another embodiment of the integrated process plant is designed with multiple features to achieve ultra high CO₂ purity (e.g., greater than 99.9 mol %, or greater than 99.99 mol %, or greater than 99.999 mol %) with minimum power consumption. The CO₂ product from the first CO₂ fractionator is let down from 550 psig to 250 psig and fed to the CO₂ polishing system, including the second distillation column (CO₂ stripper), the CO₂ stripper booster compressor and the heat integrated condenser/reboiler network. The separation of CO₂ and light impurities are enhanced at lower pressure, which enables ultra high purity CO₂ to be produced at the CO₂ stripper bottoms. The CO₂ stripper overhead vapor is then compressed to approximately 570 psig. It flows through the CO₂ stripper reboiler to reboil the column and is cooled down. It is further cooled and partially condensed using the CO₂ product as the cooling medium, and then routed to the reflux drum where the condensed liquid is totally refluxed, while the vapor is recycled back to the bottoms of the first CO₂ fractionator.

The CO₂ polishing system is designed with a low pressure cryogenic fractionation column to treat the CO₂ liquid from the first column to achieve ultra high CO₂ purity (e.g., greater than 99.9 mol %, or greater than 99.99 mol %, or greater than 99.999 mol %) with minimum utility consumption due to heat integration. The only utility consumption during normal operation is electric power.

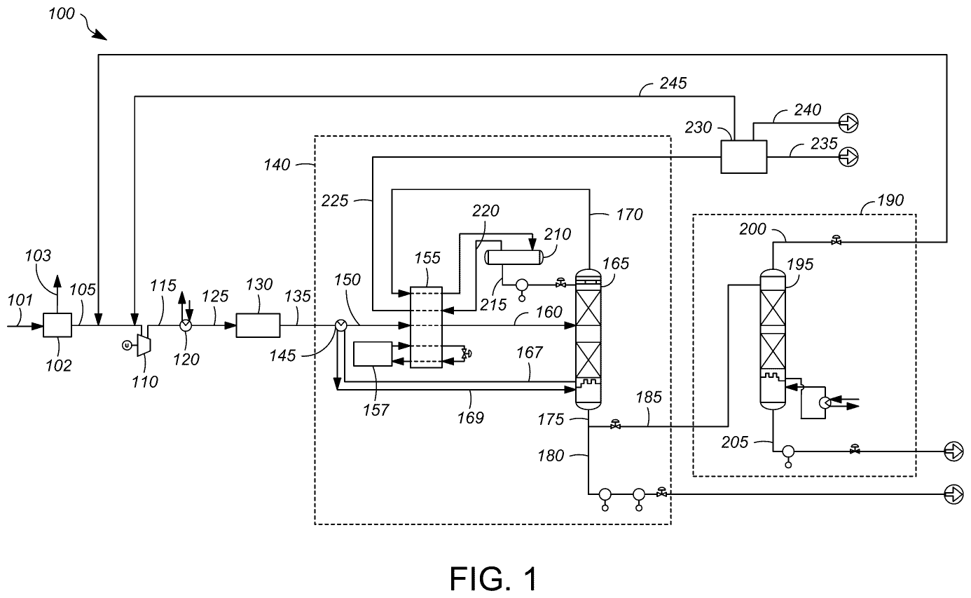

FIG. 1 illustrates one embodiment of a process 100 for producing two CO₂ streams having different purities.

The CO₂ containing stream 105 is compressed in feed compressor 110. The compressed feed gas stream 115 is cooled in cooler 120, and the cooled compressed feed gas stream 125 is dehydrated in dehydration unit 130.

The dehydrated feed gas stream 135 is sent to the CO₂ fractionation zone 140. The dehydrated feed gas stream 135 is cooled in a CO₂ fractionation reboiler 145. The cooled gas stream 150 is sent to the main heat exchanger 155 where it is chilled. The main heat exchanger 155 includes a refrigerant system 157 for chilling.

The chilled stream 160 from the main heat exchanger 155 is sent to the CO₂ fractionation column 165 where it is separated into an overhead stream 170 and a bottom stream 175. A reboiler stream 167 from the CO₂ fractionation column 165 is sent to the CO₂ fractionation reboiler 145 to cool the dehydrated feed gas stream 135, and the warmed reboiler stream 169 is returned to the CO₂ fractionation column 165.

The bottom stream 175 is divided into two portions. The first portion is recovered as the first CO₂ product stream 180.

The second portion 185 is sent to the CO₂ polishing zone 190 which includes a CO stripper column 195. The second portion 185 is separated into an overhead stream 200 and a bottom stream which is recovered as the second CO₂ product stream 205.

The overhead stream 200 from the CO₂ stripper column 195 is recycled to the feed compressor 110.

The overhead stream 170 from the CO₂ fractionation column 165 is chilled in the main heat exchanger 155 and sent to CO₂ fractionation reflux drum 210. Liquid stream 215 is refluxed to the CO₂ fractionation column 165.

The vapor stream 220 is heated in the main heat exchanger 155. The heated vapor stream 225 is sent to a pressure swing adsorption system 230 where it is separated into a high pressure hydrogen stream 235, a fuel gas stream 240, and a low pressure CO₂ stream 245 which is recycled to the feed compressor 110. The pressure swing adsorption system 230 may comprise one or more individual PSA units.

In order to increase the concentration of CO₂ in a stream from a cement production process, a fluid-catalytic cracking (FCC) process, an autothermal reforming hydrogen plant, or an SMR hydrogen plant, for example, the stream may be sent to a PSA system. A stream 101 from the process is sent to the PSA system 102 for separation into a high-pressure gas stream 103 and a tail gas stream 105 (i.e. the CO₂ containing stream 105), which is then processed as described above. The high-pressure gas stream 103 may comprise high-purity hydrogen (e.g., if the CO₂ containing stream is syngas from an SMR or autothermal reforming hydrogen plant), or the high-pressure gas stream 103 may comprise nitrogen and oxygen (e.g., if the CO₂ containing stream is from a cement production process).

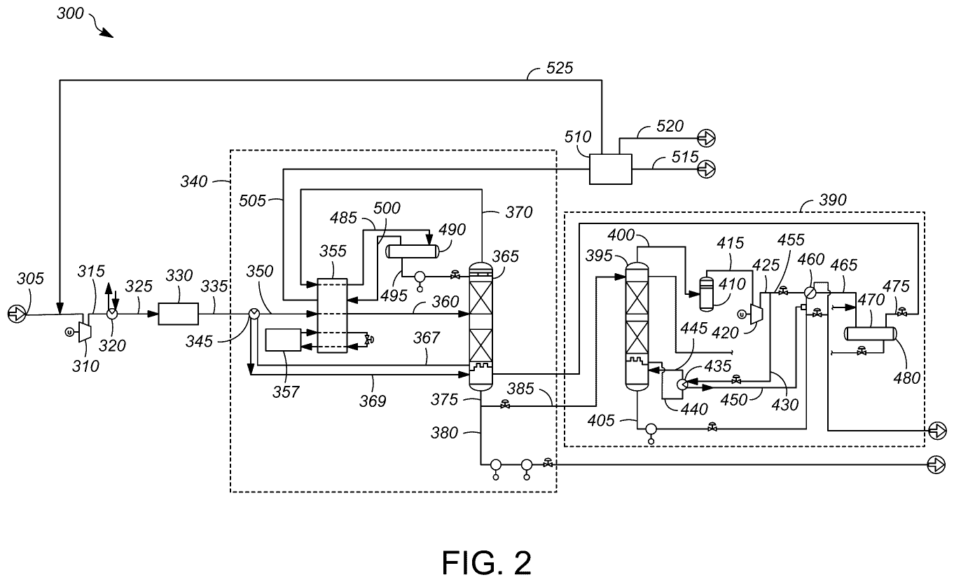

FIG. 2 illustrates another embodiment of the integrated process 300.

The CO₂ containing stream 305 is compressed in feed compressor 310. The compressed feed gas stream 315 is cooled in cooler 320, and the cooled compressed feed gas stream 325 is dehydrated in dehydration unit 330.

The dehydrated feed gas stream 335 is sent to the CO₂ fractionation zone 340. The dehydrated feed gas stream 335 is cooled in a CO₂ fractionation reboiler 345. The cooled gas stream 350 is sent to the main heat exchanger 355 where it is further chilled. The main heat exchanger 355 includes a refrigerant system 357 for chilling.

The chilled stream 360 from the main heat exchanger 355 is sent to the CO₂ fractionation column 365 where it is separated into an overhead stream 370 and a bottom stream 375. A reboiler stream 367 from the CO₂ fractionation column 365 is sent to the CO₂ fractionation reboiler 345 to cool the dehydrated feed gas stream 335, and the warmed stream 369 is returned to the CO₂ fractionation column 365.

The bottom stream 375 is divided into two portions. The first portion is recovered as the first CO₂ product stream 380.

The second portion 385 of the bottom stream 375 is sent to the CO₂ polishing zone 390 which includes a CO₂ stripper column 395. The second portion 385 is separated into an overhead stream 400 and a CO₂ product stream 405.

The overhead stream 400 from the CO₂ stripper column 395 is sent to a compressor suction drum 410 with a coalescing filter where liquid droplets are removed from the vapor stream. The vapor stream 415 is sent to a CO₂ stripper booster compressor 420 to produce a compressed stripper overhead stream 425. One portion 430 of the compressed stripper overhead stream 425 is cooled by reboiler stream 440 in the CO₂ stripper reboiler 435 forming a warmed reboiler stream 445 which is returned to the CO₂ stripper column 395 and a cooled first portion 450 of the compressed stripper overhead stream 425.

The second portion 455 of the compressed stripper overhead stream 425 is partially condensed in CO₂ stripper condenser 460 by heat exchange with CO₂ product stream 405. The partially condensed stripper overhead stream 465 is combined with the cooled first portion 450 of the compressed stripper overhead stream 425 and sent to the CO₂ stripper reflux drum 470.

The vapor stream 475 from the CO₂ stripper reflux drum 470 is sent to the bottom of the CO₂ fractionation column 365. The liquid stream 480 from the CO₂ stripper reflux drum 470 is refluxed to the CO₂ stripper column 395.

The CO₂ product stream 405 from the CO₂ stripper column 395 passes through the CO₂ stripper condenser 460 and is recovered as the second CO₂ product stream 405.

The overhead stream 370 is chilled and partially condensed in the main heat exchanger 355, and the chilled overhead stream 485 is sent to the sent to the CO₂ fractionation reflux drum 490. Liquid stream 495 is refluxed to the CO₂ fractionation column 365.

The vapor stream 500 is heated in the main heat exchanger 355. The heated vapor stream 505 is sent to a pressure swing adsorption system 510 where it is separated into a high pressure hydrogen stream 515, a fuel gas stream 520, and a low pressure CO₂ stream 525 which is recycled to the feed compressor 310. The pressure swing adsorption system 510 may comprise one or more individual PSA units.

The CO₂ containing stream 305 may be the tail gas stream from a PSA system as described above with respect to FIG. 1.

### EXAMPLE

A computer simulation was performed for the process in FIG. 1. Results are shown below in Table 1. The CO₂ containing stream 105 was obtained from two SMR hydrogen production process units (combined hydrogen PSA tail gas from both plants). A first ultra-high purity CO₂ liquid stream 205 was produced from the second fractionation column (CO₂ stripper); cooling water was used to reboil this column. This ultra-high purity CO₂ product was sent to beverage-grade sales. A second lower purity CO₂ product 180 was produced in the main fractionation column. This lower purity product was sent to a high-pressure CO₂ pipeline for ultimate geologic sequestration. The warmed overhead vapor stream 225 from the first column was passed to a PSA system comprising two PSA units to produce a hydrogen product stream 235 and a fuel gas stream 240.

TABLE 1
Material Balance for Recovery of Two CO₂ Product
Streams from SMR Hydrogen Plant Tail Gas

| | Stream # in FIG. 1 | | | | | | | |
|---|---|---|---|---|---|---|---|---|
| | 105 | 205 | | 180 | | 235 | | 240 |
| Molar Flow, | 3719 | 142 | | 2226 | | 864 | | 450 |
| kgmol/hr | | | | | | | | |
| Pressure, bar (g) | 2.5 | 14.1 | | 100 | | 33.0 | | 0.34 |
| Temperature, ° C. | 30 | −28 | | 10 | | 40 | | 30 |
| Composition, mol % | | | | | | | | |
| CO₂ | 63.2 | >99.9 | | 99.1 | | <1 | ppmv | 0.3 |
| H₂ | 25.8 | <5 | ppmv | <10 | ppmv | >99.9 | | 21.5 |
| C1 | 7.3 | <20 | ppmv | 0.9 | | <500 | ppmv | 56.4 |
| CO | 2.2 | <10 | ppmv | <20 | ppmv | <10 | ppmv | 18.1 |
| N₂ | 0.4 | <10 | ppmv | <10 | ppmv | <500 | ppmv | 3.7 |
| Water | 1.1 | <10 | ppmv | <10 | ppmv | <1 | ppmv | 0.0 |

| | | | | | |
|---|---|---|---|---|---|
| Total | 100.0 | 100.0 | 100.0 | 100.0 | 100.0 |

### Specific Embodiments

While the following is described in conjunction with specific embodiments, it will be understood that this description is intended to illustrate and not limit the scope of the preceding description and the appended claims.

A first embodiment of the invention is a process for producing an ultra high purity CO₂ stream comprising separating a CO₂ containing stream in a first cryogenic CO₂ fractionation column into a first overhead stream and a first CO₂ bottoms stream; and separating the first CO₂ bottoms stream into a second overhead stream and a CO₂ product stream comprising ultra high purity CO₂ in a second CO₂ fractionation column; wherein the second CO₂ fractionation column has a pressure less than a pressure of the first CO₂ fractionation column. An embodiment of the invention is one, any or all of prior embodiments in this paragraph up through the first embodiment in this paragraph further comprising compressing and partially condensing the second overhead stream to form a partially condensed overhead stream. An embodiment of the invention is one, any or all of prior embodiments in this paragraph up through the first embodiment in this paragraph further comprising separating the partially condensed overhead stream into a vapor stream and a reflux liquid stream; and passing the vapor stream to the first cryogenic CO₂ fractionation column. An embodiment of the invention is one, any or all of prior embodiments in this paragraph up through the first embodiment in this paragraph further comprising refluxing the reflux liquid stream to the second CO₂ fractionation column. An embodiment of the invention is one, any or all of prior embodiments in this paragraph up through the first embodiment in this paragraph further comprising cooling at least a portion of the overhead stream with the CO₂ product stream. An embodiment of the invention is one, any or all of prior embodiments in this paragraph up through the first embodiment in this paragraph further comprising cooling at least a portion of the partially condensed overhead stream with a reboiler stream from the second CO₂ fractionation column. An embodiment of the invention is one, any or all of prior embodiments in this paragraph up through the first embodiment in this paragraph further comprising dividing the first CO₂ bottoms stream into a first portion and a second portion before separating the first CO₂ bottoms stream in the second CO₂ fractionation column; and recovering the second portion of the first CO₂ bottoms stream, the second portion of the first CO₂ bottoms stream having a lower purity than the CO₂ product stream; wherein separating the first CO₂ bottoms stream in the second CO₂ fractionation column comprises separating the first portion of the first CO₂ bottoms stream in the second CO₂ fractionation column. An embodiment of the invention is one, any or all of prior embodiments in this paragraph up through the first embodiment in this paragraph further comprising recycling the second overhead stream to the first cryogenic CO₂ fractionation column. An embodiment of the invention is one, any or all of prior embodiments in this paragraph up through the first embodiment in this paragraph further comprising cooling the first overhead stream forming a cooled first overhead stream; separating the cooled first overhead stream into a first liquid stream and a first vapor stream; warming the first vapor stream; separating the first vapor stream in a pressure swing adsorption (PSA) system into a high-pressure gas stream and a low-pressure CO₂-rich tail gas stream; and recycling the tail gas stream to the first cryogenic CO₂ fractionation column. An embodiment of the invention is one, any or all of prior embodiments in this paragraph up through the first embodiment in this paragraph further comprising compressing the CO₂ containing stream forming a compressed CO₂ containing stream; dehydrating the compressed CO₂ containing stream; and cooling the compressed CO₂ containing stream forming a cooled compressed CO₂ containing stream before separating the CO₂ containing stream in the first cryogenic CO₂ fractionation column. An embodiment of the invention is one, any or all of prior embodiments in this paragraph up through the first embodiment in this paragraph further comprising separating a feed stream in a feed PSA system forming a first high-pressure gas stream and a first low-pressure CO₂-rich tail gas stream; and wherein the CO₂ containing stream comprises the first low-pressure CO₂-rich tail gas stream.

A second embodiment of the invention is a process for producing two CO₂ product streams comprising separating a CO₂ containing stream in a first cryogenic CO₂ fractionation column into a first overhead stream and a first CO₂ bottoms stream; dividing the first CO₂ bottoms stream into a first portion and a second portion; separating the first portion of the first CO₂ bottoms stream into a second overhead stream and a CO₂ product stream comprising CO₂ having a first purity in a second CO₂ fractionation column; recovering the CO₂ product stream; and recovering the second portion of the first CO₂ bottoms stream as a second CO₂ product stream, the second CO₂ product stream having a second purity less than the first purity; separating the first overhead stream in a pressure swing adsorption (PSA) system into a CO2-lean high-pressure stream and a CO2-rich low-pressure tail gas stream; and recycling the tail gas stream to the first cryogenic CO₂ fractionation column. An embodiment of the invention is one, any or all of prior embodiments in this paragraph up through the second embodiment in this paragraph further comprising compressing and partially condensing the second overhead stream to form a partially condensed overhead stream; separating the partially condensed overhead stream into a vapor stream and a reflux liquid stream; passing the vapor stream to the first cryogenic CO₂ fractionation column; and refluxing the reflux liquid stream to the second CO₂ fractionation column. An embodiment of the invention is one, any or all of prior embodiments in this paragraph up through the second embodiment in this paragraph further comprising cooling at least a portion of the overhead stream with the CO₂ product stream. An embodiment of the invention is one, any or all of prior embodiments in this paragraph up through the second embodiment in this paragraph further comprising cooling at least a portion of the overhead stream with a reboiler stream from the second CO₂ fractionation column. An embodiment of the invention is one, any or all of prior embodiments in this paragraph up through the second embodiment in this paragraph further comprising dividing the first CO₂ bottoms stream into a first portion and a second portion before separating the first CO₂ bottoms stream in the second CO₂ fractionation column; and recovering the second portion of the first CO₂ bottoms stream, the second portion of the first CO₂ bottoms stream having a lower purity than the CO₂ product stream; wherein separating the first CO₂ bottoms stream in the second CO₂ fractionation column comprises separating the first portion of the first CO₂ bottoms stream in the second CO₂ fractionation column. An embodiment of the invention is one, any or all of prior embodiments in this paragraph up through the second embodiment in this paragraph further comprising recycling the second overhead stream to the first cryogenic CO₂ fractionation column. An embodiment of the invention is one, any or all of prior embodiments in this paragraph up through the second embodiment in this paragraph further comprising cooling the first overhead stream forming a cooled first overhead stream; separating the cooled first overhead stream into a first liquid stream and a first vapor stream; warming the first vapor stream; separating the first vapor stream in a pressure swing adsorption (PSA) system into a high-pressure gas stream and a low-pressure CO₂-rich tail gas stream; and recycling the tail gas stream to the first cryogenic CO₂ fractionation column. An embodiment of the invention is one, any or all of prior embodiments in this paragraph up through the second embodiment in this paragraph further comprising compressing the CO₂ containing stream forming a compressed CO₂ containing stream; dehydrating the compressed CO₂ containing stream; and cooling the compressed CO₂ containing stream forming a cooled compressed CO₂ containing stream before separating the CO₂ containing stream in the first cryogenic CO₂ fractionation column. An embodiment of the invention is one, any or all of prior embodiments in this paragraph up through the second embodiment in this paragraph further comprising separating a feed stream in a feed PSA system forming a first high-pressure gas stream and a first low-pressure CO₂-rich tail gas stream; and wherein the CO₂ containing stream comprises the first low-pressure CO₂-rich tail gas stream.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for producing an ultra high purity CO₂ stream comprising:
separating a CO₂ containing stream in a first cryogenic CO₂ fractionation column into a first overhead stream and a first CO₂ bottoms stream; and
separating the first CO₂ bottoms stream into a second overhead stream and a CO₂ product stream comprising ultra high purity CO₂ in a second CO₂ fractionation column; and
wherein the second CO₂ fractionation column has a pressure less than a pressure of the first CO₂ fractionation column.

2. The process of claim 1 further comprising:
compressing and partially condensing the second overhead stream to form a partially condensed overhead stream.

3. The process of claim 2 further comprising:
separating the partially condensed overhead stream into a vapor stream and a reflux liquid stream; and
passing the vapor stream to the first cryogenic CO₂ fractionation column.

4. The process of claim 3 further comprising:
refluxing the reflux liquid stream to the second CO₂ fractionation column.

5. The process of claim 2 further comprising:
cooling at least a portion of the overhead stream with the CO₂ product stream.

6. The process of claim 2 further comprising:
cooling at least a portion of the partially condensed overhead stream with a reboiler stream from the second CO₂ fractionation column.

7. The process of claim 1 further comprising:
dividing the first CO₂ bottoms stream into a first portion and a second portion before separating the first CO₂ bottoms stream in the second CO₂ fractionation column; and
recovering the second portion of the first CO₂ bottoms stream, the second portion of the first CO₂ bottoms stream having a lower purity than the CO₂ product stream; and
wherein separating the first CO₂ bottoms stream in the second CO₂ fractionation column comprises separating the first portion of the first CO₂ bottoms stream in the second CO₂ fractionation column.

8. The process of claim 1 further comprising:
recycling the second overhead stream to the first cryogenic CO₂ fractionation column.

9. The process of claim 1 further comprising:
cooling the first overhead stream forming a cooled first overhead stream;
separating the cooled first overhead stream into a first liquid stream and a first vapor stream;
warming the first vapor stream;
separating the first vapor stream in a pressure swing adsorption (PSA) system into a high-pressure gas stream and a low-pressure CO₂-rich tail gas stream; and
recycling the tail gas stream to the first cryogenic CO₂ fractionation column.

10. The process of claim 1 further comprising:
compressing the CO₂ containing stream forming a compressed CO₂ containing stream;
dehydrating the compressed CO₂ containing stream; and
cooling the compressed CO₂ containing stream forming a cooled compressed CO₂ containing stream before separating the CO₂ containing stream in the first cryogenic CO₂ fractionation column.

11. The process of claim 1 further comprising:
separating a feed stream in a feed PSA system forming a first high-pressure gas stream and a first low-pressure CO₂-rich tail gas stream; and
and wherein the CO₂ containing stream comprises the first low-pressure CO₂-rich tail gas stream.

12. A process for producing two CO₂ product streams comprising:
separating a CO₂ containing stream in a first cryogenic CO₂ fractionation column into a first overhead stream and a first CO₂ bottoms stream;
dividing the first CO₂ bottoms stream into a first portion and a second portion;
separating the first portion of the first CO₂ bottoms stream into a second overhead stream and a CO₂ product stream comprising CO₂ having a first purity in a second CO₂ fractionation column;
recovering the CO₂ product stream;
recovering the second portion of the first CO₂ bottoms stream as a second CO₂ product stream, the second CO₂ product stream having a second purity less than the first purity;
separating the first overhead stream in a pressure swing adsorption (PSA) system into a CO₂-lean high-pressure stream and a CO₂-rich low-pressure tail gas stream; and
recycling the tail gas stream to the first cryogenic CO₂ fractionation column.

13. The process of claim 12 further comprising:
compressing and partially condensing the second overhead stream to form a partially condensed overhead stream;
separating the partially condensed overhead stream into a vapor stream and a reflux liquid stream;
passing the vapor stream to the first cryogenic CO₂ fractionation column; and
refluxing the reflux liquid stream to the second CO₂ fractionation column.

14. The process of claim 13 further comprising:
cooling at least a portion of the overhead stream with the CO₂ product stream.

15. The process of claim 13 further comprising:
cooling at least a portion of the overhead stream with a reboiler stream from the second CO₂ fractionation column.

16. The process of claim 12 further comprising:
dividing the first CO₂ bottoms stream into a first portion and a second portion before separating the first CO₂ bottoms stream in the second CO₂ fractionation column; and
recovering the second portion of the first CO₂ bottoms stream, the second portion of the first CO₂ bottoms stream having a lower purity than the CO₂ product stream; and
wherein separating the first CO₂ bottoms stream in the second CO₂ fractionation column comprises separating the first portion of the first CO₂ bottoms stream in the second CO₂ fractionation column.

17. The process of claim 12 further comprising:
recycling the second overhead stream to the first cryogenic CO₂ fractionation column.

18. The process of claim 12 further comprising:
cooling the first overhead stream forming a cooled first overhead stream;
separating the cooled first overhead stream into a first liquid stream and a first vapor stream;
warming the first vapor stream;
separating the first vapor stream in a pressure swing adsorption (PSA) system into a high-pressure gas stream and a low-pressure CO₂-rich tail gas stream; and
recycling the tail gas stream to the first cryogenic CO₂ fractionation column.

19. The process of claim 1 further comprising:
compressing the CO₂ containing stream forming a compressed CO₂ containing stream;
dehydrating the compressed CO₂ containing stream; and
cooling the compressed CO₂ containing stream forming a cooled compressed CO₂ containing stream before separating the CO₂ containing stream in the first cryogenic CO₂ fractionation column.

20. The process of claim 12 further comprising:
separating a feed stream in a feed PSA system forming a first high-pressure gas stream and a first low-pressure CO₂-rich tail gas stream; and
wherein the CO₂ containing stream comprises the first low-pressure CO₂-rich tail gas stream.
